(19) United States
(12) Patent Application Publication
(10) Pub. No.: US 2007/0188488 A1
(43) Pub. Date: Aug. 16, 2007

(54) Computer network-based 3D rendering system

(76) Inventor: Justin Y. Choi, Cerritos, CA (US)

Correspondence Address: CHRISTIE, PARKER & HALE, LLP, PO BOX 7068, PASADENA, CA, 91109-7068, US

(21) Appl. No.: 11/654,402

(22) Filed: Jan. 16, 2007

Related U.S. Application Data
(60) Provisional application No. 60/758,844, filed on Jan. 13, 2006.

(51) Int. Cl. G06T 15/00

(52) U.S. Cl. 345/419

(57) ABSTRACT

A computer network-based 3D rendering system. A client computer is coupled to a server over a computer network (e.g., Internet). A user uses a front-end interface to manipulate lower resolution 3D objects at a client computer, sends the parameters of the 3D objects to the server, which generates a higher resolution 3D model. The server then generates a high resolution 2D image (e.g., JPEG), and sends it to the client computer for display. The server may include a video card for generating high quality 2D images. The 3D rendering system allows the client computer to display a high quality image regardless of the capabilities of the client computer. Further, use of the video card at the server allows high quality 2D images to have a better resolution than those available in video games, but at a higher speed than a conventional 3D rendering software that runs on CPU, for example.

### CROSS-REFERENCE TO RELATED APPLICATION

This application claims priority to and the benefit of U.S. Provisional Application No. 60/758,844 filed Jan. 13, 2006, the entire content of which is incorporated herein by reference.

### FIELD OF THE INVENTION

The present invention relates to a 3D rendering system, and more particularly, to a computer network-based 3D rendering system in which image parameters generated by a client computer are sent to a server to render a high quality 3D model.

### BACKGROUND

To create graphics images for video games, users often rely on DirectX®, which is a 3D rendering language for hardware typically used for video games. DIRECTX® is a registered trademark of Microsoft Corporation, Redmond, Wash. DirectX render programs typically require high-end video cards to achieve high quality images. Further, DirectX render engines are used for video games and often sacrifice image quality to meet the demands of rendering multiple 3D models and managing physics in real-time at 30 or more frames per second. These programs typically reside on the user's (client) machine so that the speed of the client machine's video card and computer determines the image quality and render speed. Even the most advanced games today do not render photo-realistic or near photo-realistic images because of the speed at which the images must be rendered.

Traditional rendering programs such as Renderman® and Brazil are used to render high quality images. RENDERMAN® is a registered trademark of Pixar Corporation, San Rafael, Calif. These programs are used in movies, architecture, and other areas where photo-realism is important and real-time rendering is not needed. These rendering programs typically require several minutes to several days to render complex images. The speed of the client machine's CPU determines the render speed where typical rendered images take several minutes or hours to produce.

When using a computer network-based 3D rendering system, it is desirable to provide a good quality image to a client computer regardless of the speed or hardware availability of the client computer. Further, it is desirable to render high quality 2D images rapidly without compromising on the image quality unlike when rendering video/graphics images for video games using DirectX rendering programs.

### BRIEF DESCRIPTION OF THE DRAWINGS

FIG. 1 is a system diagram of a computer network-based 3D rendering system in an exemplary embodiment according to the present invention;

FIG. 2 is a flow diagram illustrating a method of using the 3D rendering system to generate a high quality 2D image and display the high quality 2D image on a display device of the client computer;

FIG. 3 is a screen shot of a user interface at a client computer in an exemplary embodiment according to the present application;

FIGS. 4A and 4B are screen shots, respectively, of a vehicle shot in the low-resolution 3D front-end, and a high quality image rendered in and by the server, and then sent back to the user as a bit map image; and

FIGS. 5A and 5B are screen shots of a 3D rendering system front-end in an exemplary embodiment of the present invention.

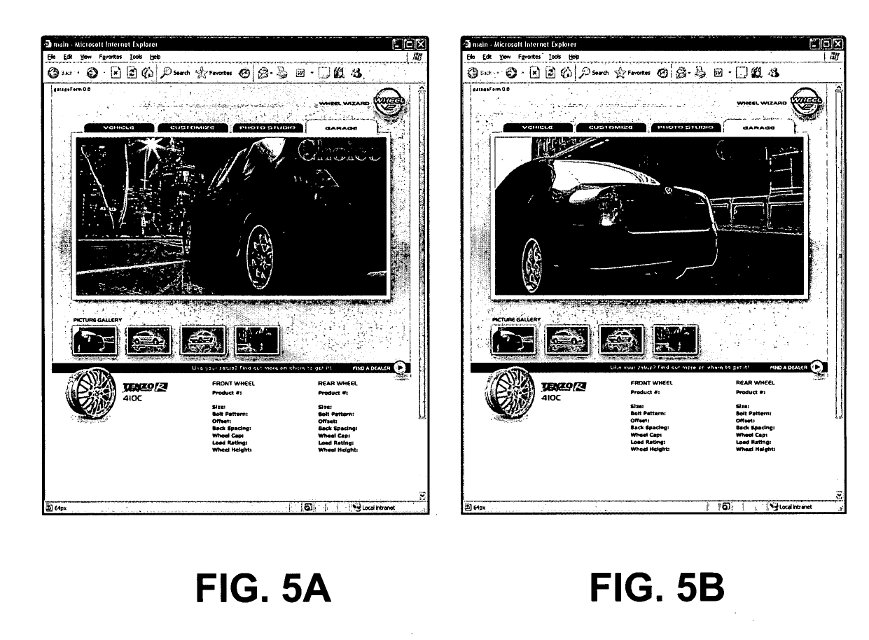

These and other aspects of the invention will be more readily comprehended in view of the discussion herein and accompanying drawings.

### SUMMARY OF THE INVENTION

In an exemplary embodiment according to the present invention, a server adapted to perform rendering of one or more second images, is provided. The server includes: a request handler adapted to receive and handle a render request to render the one or more second images using parameters for a first image associated with the render request; a rendering engine for generating a 3D object using the parameters, and for rendering the one or more second images using the 3D object; and a processor adapted to control the request handler and the rendering engine, wherein the one or more second images have a higher resolution than the first image.

In another exemplary embodiment according to the present invention, a network-based image rendering system is provided. The system includes: at least one client computer adapted to generate parameters for a first object having a first resolution; and a server adapted to receive the parameters for the first object and generate a second object having a second resolution that is greater than the first resolution, wherein the at least one client computer is coupled to the server via a computer network, wherein the server is further adapted to render one or more 2D images using the second object, and to send the one or more 2D images to the at least one client computer over the computer network.

In yet another exemplary embodiment according to the present invention, a method of generating one or more second images having a second resolution at a server, using parameters for a first image having a first resolution that is lower than the second resolution, is provided. The method includes: receiving at the server a render request and the parameters for the first image from a client computer; generating a 3D object corresponding to the one or more second images using the parameters for the first image; rendering the one or more second images using the 3D object; and sending the one or more second images from the server to the client computer.

### DETAILED DESCRIPTION

In most video games, images are rendered 30 times per second or more, which means that each image must be rendered at about three one hundredths of a second or less. Higher image quality requires more render time. The 3D rendering system in exemplary embodiments of the present invention allows for a render time of up to one second. In other embodiments, the render time may be more or less than one second, but preferably less than the time (e.g., days or hours) typically required for photo-realistic images used for movies. Since there is no need to worry about what type of video card is on the client's machine, the render system on the server can use the most advanced video card on the market today, and the rendering features only found on these video cards can be utilized. Further, since, the high-end video card on the server can be upgraded as the technology evolves, the 3D rendering system of the present invention can be upgraded without improving hardware and/or software at the client end.

In an exemplary embodiment of the present invention, a computer network-based rendering system is provided. A user uses a front-end interface to manipulate one or more 2D or 3D objects at a client computer (e.g., as a snap shot), and sends parameters of the 3D objects to a server for generating a typically higher resolution 3D model. The server then renders a 2D image of the 3D model and sends the 2D image back to the client computer to be displayed.

In another exemplary embodiment of the present invention, a video card is provided at a server to render high quality 2D images using initially lower quality 3D objects.

In another exemplary embodiment of the present invention, a computer network-based 3D rendering system includes a 3D camera input system. Using the 3D camera input system, a user at a client computer can create inputs for camera angles, zooms, pans, and so forth on the front-end and have a server deliver a corresponding animation or video file. The server creates the video file as a series of images, puts the images into a standard video format, and sends the video file back to the client computer.

According to an aspect of the present invention, a computer network-based (e.g., web or the Internet-based) 3D rendering system is provided. The 3D rendering system enables a user to use a low-resolution 3D environment to set up a single “shot” or camera “path” and then have that image or path rendered as a series of images (video) rendered in high detail. This way, the user uses a front-end interface to manipulate one or more 3D objects and sends the 3D object or parameters thereof to a server over the computer network, which generates a higher resolution 3D model. By way of example, the lower resolution 3D object may have been generated using 5,000 to 20,000 polygons, whereas the higher resolution 3D model may include 100,000 to 500,000 polygons.

The server generates a 2D image (e.g., JPEG) or images of the higher resolution 3D model, and sends the 2D image or images to the client. Here, the final rendered image is created on the server and can be delivered to the client computer as a standard 2D image such as a JPEG file, a video file (such as a Quicktime® or Windows Media® file), or as a Macromedia Flash® SWF or FLV file. This way, regardless of the type or quality of the video card used at a client computer, high quality images may be displayed at the client computer because the server can generate higher quality images and provide them to the client computer. QUICKTIME® is a registered trademark of Apple Computer, Inc., Cupertino, Calif. WINDOWS MEDIA® is a registered trademark of Microsoft Corporation, Redmond, Wash. MACROMEDIA FLASH® is a registered trademark of Adobe Systems Incorporated, San Jose, Calif.

According to another aspect of the present invention, video game technology is used to generate relatively high resolution 3D models relatively fast to rapidly render high quality 2D images. A video card is used at a server to generate high quality 3D models and 2D images, so that the type of video card used at the client side is not relevant to the quality of the images rendered by the server. By way of example, DirectX technology can be used at the server while at the client side, Macromedia Flash® may be used for the interface, and Viewpoint® may be used for the front-end 3D system. VIEWPOINT® is a registered trademark of Viewpoint Corporation, New York, N.Y.

By using a video card instead of relying solely on software rendering programs at the server end, high quality images can be rendered relatively quickly. Also, since more time is available (e.g., on the order of half a second) to the server to generate high quality images than that available (e.g., 30 frames per second (or 33 ms per frame)) for a video game device, the 3D models generated, and therefore 2D images rendered, by the server can have higher quality than those generated for video games.

The following three requirements should be met by the computer network-based 3D rendering system in one exemplary embodiment: 1) The 3D rendering system should be platform-independent at the client computer. Therefore, the 3D rendering software cannot rely on the hardware configuration of the client machine; 2) The 3D rendering system should also render high quality images quickly, typically in under one second; 3) Further, the 3D rendering system should be able to handle a high volume of render requests since multiple client computers may try to access the 3D rendering system at substantially the same time. The computer network-based 3D rendering system in other embodiments may have other requirements such as different time limits for rendering high quality images.

To do this, DirectX technology has been selected for use at the server in one exemplary embodiment because of its speed. Standard DirectX rendering programs may not produce the image quality suitable for the 3D rendering system of the present invention. Thus, a custom rendering program has been developed based on the DirectX technology. Those skilled in the art would know how to develop and use such rendering program based on the disclosure of the present application. Further, the language used is not critical but the fact that these systems are used for video games where images must be rendered quickly is important for this particular embodiment. In other embodiments, other suitable competing technologies for hardware rendering languages such as OpenGL® may be used instead of or in addition to, the DirectX technology. OPENGL® is a registered trademark of Silicon Graphics, Inc., Mountain View, Calif.

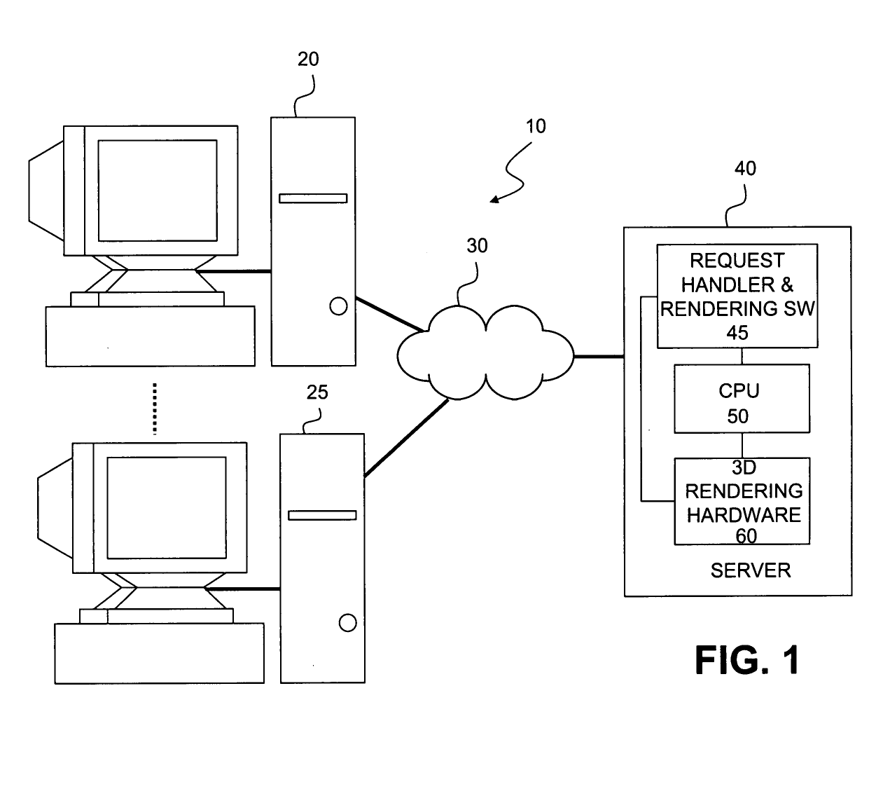

FIG. 1 is a system diagram of a 3D rendering system 10 in an exemplary embodiment according to the present invention. In the 3D rendering system 10, client computers 20 and 25 are coupled to a server 40 through a computer network 30, which may also be referred to as a global computer network and may include one or more of the Internet, local area network (LAN), intranet, and the like. While FIG. 1 illustrates that only the client computers 20, 25 and the server 40 are coupled to the computer network 30, in practice, a vast array of different types of computers and other devices may be coupled to the computer network 30.

The server 40 includes a request handler and renderer software 45, a central processing unit (CPU) 50 and a 3D rendering hardware 60, which may be a video card, graphics card or a video/graphics card. In a particular embodiment, for example, the video card used is NVidia® Quadro FX4300, but is not limited thereto, and upgraded video cards may be used as the technology evolves without departing from the spirit or scope of the present invention. NVIDIA® is a registered trademark of NVidia Corporation, Santa Clara, Calif.

While the server 40 is shown as including only the request handler and renderer software 45, the CPU 50 and the 3D rendering hardware 60, in practice, the server 40 may include a number of other devices such as a hard disk drive, memory, support chips, communication devices (e.g., ports), and/or the like, as is known to those skilled in the art. While the CPU 50 serves as the main processor of the server 40, the high quality rendering of the 3D image received from the client computer 20 or 25 is performed by the 3D rendering hardware 60. The request handler 45 receives the requests for 3D rendering made by the client computers 20 and/or 25 as well as one or more other client computers, and provides rendered high quality 2D image or images to the client computers. The request handler 45 may be implemented using hardware, software, firmware or any combination thereof. By way of example, the request handler 45 may include routines run on the CPU 50.

The client computers 20 and 25 may have different processors, peripherals, video and/or graphics cards and/or processing capabilities. Accordingly, the qualities (e.g., resolution) and/or display speeds of 3D or other images of the client computers 20 and 25 may be different. Regardless of the types of hardware in the computers 20 and 25, however, the server 40 is capable of generating a high quality 3D object or objects, and is capable of generating and sending a corresponding high quality 2D image or images to the client computer using the parameters for the respective lower quality 3D objects sent by the corresponding client computer.

While the client computers 20 and 25 may have different hardware and processing speeds, and may be located at different, and may be distant locations, since the operation of the 3D rendering system according to exemplary embodiments of the present invention is substantially the same for both the client computers, the exemplary embodiment will be described primarily in reference to the client computer 20. The operation of the 3D rendering system using the client computer 25 is substantially the same as that using the client computer 25.

The client computer 20 in the exemplary embodiment serves as a web-based front-end with low-resolution 3D, which works together with a server-based high-resolution render program, which runs on the server 40 using the 3D rendering hardware 60, for example. This enables users to customize a product or environment such as a home interior, vehicle, and so forth, in 3D and then receive a photo-realistic image or images of that product without the need for a sophisticated video card or high-speed processors on their machine. It should be noted that user inputs on the front-end do not have to be in 3D. The user inputs on the front-end may also be set up as a text-based or 2D based system.

Of course, the 3D model (e.g., lower resolution 3D image) allows for a better user experience but it is not necessary for the server-based render system to function. By way of example, the client computers in other embodiments may use higher or lower resolution 3D objects and/or 2D images than the client computer 20 to generate input parameters, as the 3D rendering system of the present invention is not limited by the video card or other hardware available for image rendering at the client side. For instance, a user may be able to generate a virtual tour video in Flash of a city or a part of a city using a 2D map to generate input parameters.

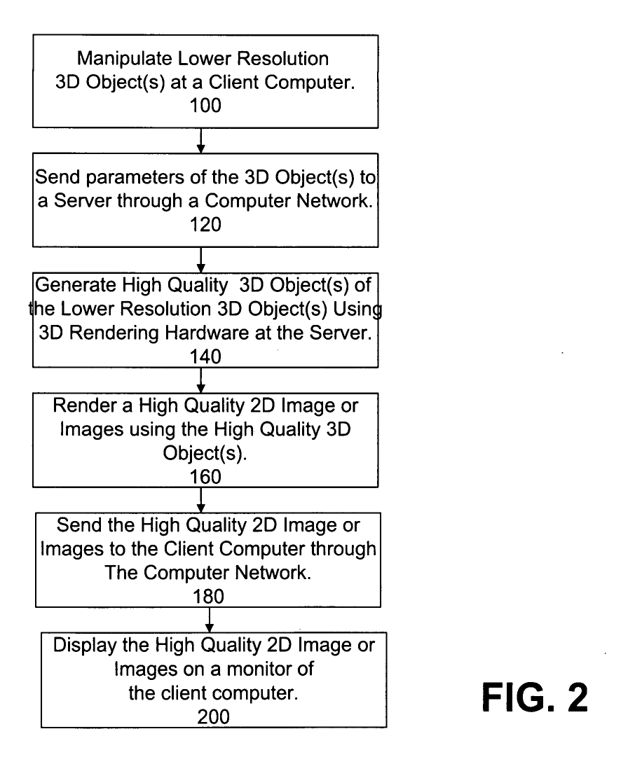

In other embodiments, the front-end interface of the computer network-based 3D rendering system may be text-based such that a high quality 3D model(s) can be generated and high quality 2D image(s) can be rendered by the server without first creating an image at the client computer. In addition to setting a “shot” or a camera angle, users may also select different configurations which are represented by a collection of low-resolution 3D models on the front-end. Accordingly, in exemplary embodiments of the present invention, the parameters for the image sent by the client computer 20 or 25 to the server 40 may correspond to a 3D model(s), a 2D image(s), text data, and/or the like. Therefore, the method shown in the flow diagram of FIG. 2 is only an exemplary embodiment for illustrative purposes only, and the present invention is not limited thereto.

The method of FIG. 2 will be described in reference to the computer network-based 3D rendering system 10 of FIG. 1. First, a user manipulates a lower resolution 3D object or objects at a client computer (100). The 3D object or objects manipulated at the client computer typically have a lower resolution than the corresponding 3D object or objects that would be generated by the server 40 (i.e., 3D rendering hardware 60), but are not limited thereto. Also, the input data manipulated at the client computer 20 or 25 may include 2D image(s) and/or text data. By way of example, in 100, the user creates his or her “shot” by manipulating a low-resolution 3D environment via his or her Internet browser.

The parameters of the manipulated 3D object(s) are sent to the server 40 through the computer network 30 (120). Then corresponding high quality 3D object or objects are generated and/or looked up using the 3D object parameters from the client computer 20 using 3D rendering hardware at the server (140). Here, the user presses a “render” button, for example, and the corresponding “shot” parameters are submitted to a server-based high resolution render engine.

The “shot” parameters may include, for example, a variety of camera settings, position, camera path (to generate a desired video), objects selected (e.g., vehicle, wheels, etc.), object settings (color of car), object positions, effects, selected backgrounds, etc. A variety of data is needed to establish the camera positions and create the scenes. The “shot” parameters may vary as those skilled in the art would appreciate.

Then a high quality 2D image (e.g., JPEG) or images (e.g., video) corresponding to the high quality 3D object or objects are generated by the 3D rendering hardware 60 and/or other suitable software/hardware in the server 40 (160). Here, the server-based render engine may recreate the “shot” and create a high quality rendered image, series of images, video, or Macromedia Flash file in under half a second. The high quality 2D image or images (e.g., video) are then sent to the client computer through the computer network 30 (180). This way, the rendered image is sent back to the front-end where it can be further manipulated by the front-end program or delivered to the user. Then the high quality 2D image or images are displayed on the client computer.

In one particular embodiment, which has been implemented for example, the program front-end was created using a combination of Macromedia Flash and Viewpoint 3D technology. The front-end interface allows the user to manipulate 3D models in a low resolution 3D environment. In this embodiment, the front-end was designed to load quickly and be platform independent. Because Internet browser plug-ins are utilized (Macromedia Flash and Viewpoint), the web-based system is accessible by the majority of Internet users. This way, the users are enabled to manipulate the render engine to create their images via an Internet browser. Existing technologies have been used: Macromedia Flash for the interface and Viewpoint for the front-end 3D system. This front-end has been adapted to communicate with the server-based render system in the described embodiment.

Viewpoint and DirectX work in completely different ways. The camera position, scale, what models were selected, the colors applied, the background environment, and the lighting parameters all have to pass from Viewpoint to the DirectX render program. All of these parameters are handled differently between Viewpoint and DirectX. Thus, a conversion program was developed. This is because there was no previously available communication program between Viewpoint and DirectX. Those skilled in the art would know how to develop and use such a conversion program, if the disclosure of the present application were made available to them.

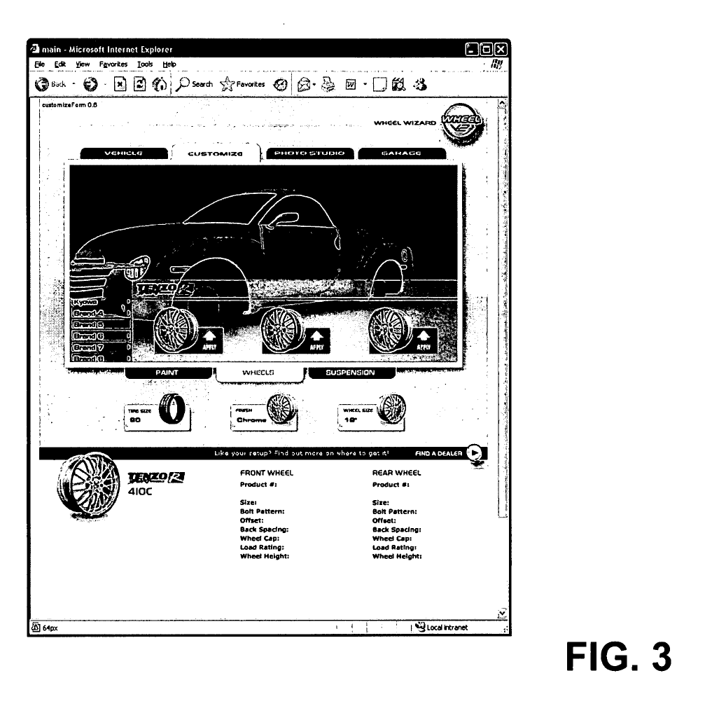

As can be seen in the screen shot of FIG. 3, using the 3D rendering system in an exemplary embodiment of the present invention, users can customize a vehicle by selecting wheels, adjusting the suspension heights, changing the vehicle color (e.g., custom and/or factory paint colors), tire profiles, and selecting from various backgrounds. The user can also adjust the camera to any angle or level of zoom to set up his or her shot.

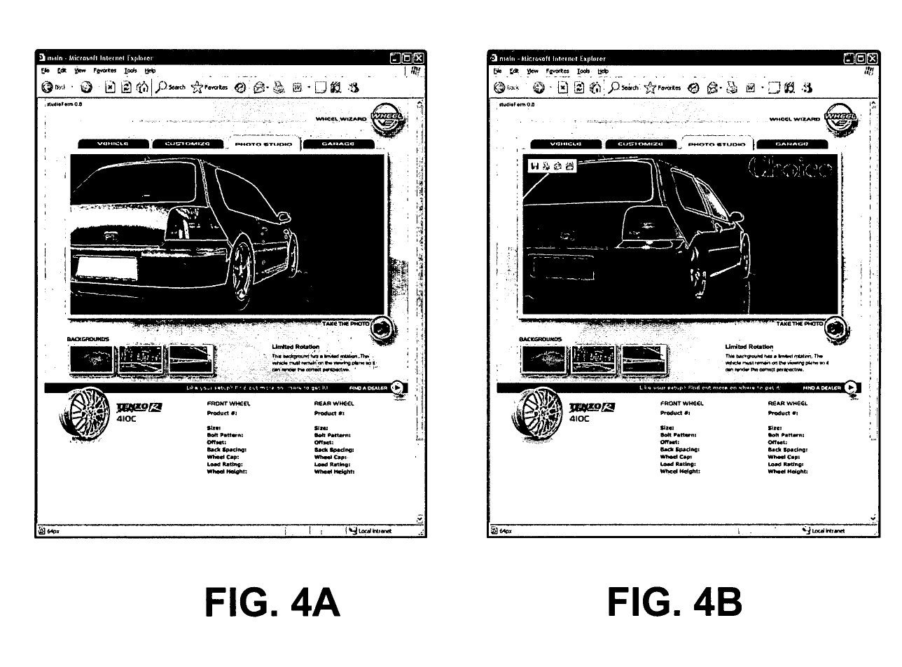

FIG. 4A is a screen shot of a front-end interface for the 3D rendering system that a user may use to configure his or her vehicle and to set up a shot in a low-resolution 3D front-end. The user, for example, may rotate or pan the camera in 360 degrees, and may also control zoom. The 3D rendering system may also allow for a user to have 360 degree control of the camera. FIG. 4B is a screen shot of a high quality 3D video/graphics image displayed on the front-end user interface. When the user presses the “Photo” button, a high quality image is rendered on the server and then sent back to the user as a bitmap image to be displayed on the front-end interface as can be seen in FIG. 4B.

By way of example in the described embodiment, clicking the “photo” or render button submits the 3D parameters as an XML file to a server-based render program. The server-based render program recreates the image using high resolution files. The server-based engine is a custom DirectX render program that uses video-card accelerated rendering. Once it renders an image, it sends it to the front-end program as a standard bitmap image such as a JPEG.

Because the render program is server-based, the speed and the quality of the image is determined by the hardware configuration of the server, and not the client machine. This enables the computer network-based 3D rendering system to deliver high quality rendered images to the user regardless of their hardware configuration.

In another exemplary embodiment according to the present invention, a computer network-based 3D rendering system includes a 3D camera input system. Using the 3D camera input system, a user can create inputs for camera angles, zooms, pans, and so forth on the front-end and have a corresponding 3D image delivered as an animation or video file, in addition to setting up a “shot”. The video file is created on the server as a series of images that are automatically put into a standard video format and sent back to the user. Hence, a number of high quality images or a series of high quality images (e.g., video) may be generated and downloaded to the client computer where it is displayed.

This system is a unique 3D camera input system on the front-end that allows users to create custom animations and videos without the need for hardware rendering on their local machines (e.g., on client computers). By way of example, the user can configure a house as follows. The user first downloads a program, and receives (e.g., from the server) low resolution objects to select, position, and manipulate. The user sets up his or her environment or shot and then sets camera paths and speeds. The user at the front-end then sends the various parameters defined by the user (e.g., through manipulating the images) to the server. The server, using the video card, then creates a video using high resolution renders from the high resolution version of those 3D objects, and sends it back to the user as a web-standard video file.

Further, such 3D camera input system has very practical implementations for Macromedia Flash. Currently, if Flash designers want to use 3D animations or any type of video in their Flash programs, they must create the videos or animations in advance. Animations and videos cannot be created dynamically from 3D models. With the 3D camera input system of the described embodiment, user or front-end inputs would often not be with 3D models. The back-end render system would create Macromedia Flash FLV or SWF files for the front-end Flash program. Because the output is an SWF or FLV file, Macromedia Flash is able to integrate these files into the front-end Flash program in a wide variety of ways. This way, by using the 3D rendering engine as the backend engine, more universal, web-friendly tools for creating high quality 2D video of 3D models is made available to the Flash developers.

By way of example, the Macromedia Flash can dynamically incorporate these animations into a user presentation. The current version of Macromedia Flash is able to dynamically call FLV or SWF files but cannot dynamically generate 3D. Since the 3D animations or images have been output in SWF or FLV format, Macromedia Flash can dynamically inert the animations into the presentation.

While the 3D camera input system has been described in reference to Macromedia Flash because it is the most popular interactive development platform, the 3D camera input system can work in other suitable development programs as well.

The computer network-based 3D rendering system also supports product pricing and e-commerce purchase so users can purchase what they configure.

Although the present invention has been described in reference to certain exemplary embodiments, those skilled in the art would understand that additional variations, substitutions and modifications can be made to the system, as disclosed, without departing form the spirit or scope of the invention.

By way of example, while the 3D rendering system of the present invention has been described primarily in reference to configuration of automobiles, the present invention is broadly applicable to 3D product preview systems for other industries as well. This may include using the 3D rendering system to allow users to configure clothing outfits and home interiors. By way of example, a high quality 3D fly through tour video of a home may be rendered by the server using low resolution 3D objects

Further, the 3D rendering system for the automobiles may be applied to include various aftermarket parts such as bumpers, spoilers, and so forth. In addition, a user may be given an option to load one or more background images to be used during rendering of the high quality 2D image or images at the server. Also, the 3D rendering engine at the server may serve as a backend engine for Flash developers for rendering high quality 2D video.

As discussed above, in exemplary embodiments according to the present invention, a 3D render system is used to provide dynamic server-side rendering for Internet and other computer network applications. This will typically be used for product visualization applications whereby the user will configure a product or group of products on a client computer and then request a high quality image of their configuration. The application will take the parameters set by the user on the client computer and then generate a high quality image of that configuration using the server-side render system. The image will then be sent back to the user within a short timeframe, usually within a few seconds.

Product visualization examples can include customization of vehicle, home interior, airplane interior, or furniture systems, but are not limited thereto.

While certain exemplary embodiments have been described above in detail and shown in the accompanying drawings, it is to be understood that such embodiments are merely illustrative of and not restrictive of the broad invention. It will thus be recognized that various modifications may be made to the illustrated and other embodiments of the invention described above, without departing from the broad inventive scope thereof. In view of the above it will be understood that the invention is not limited to the particular embodiments or arrangements disclosed, but is rather intended to cover any changes, adaptations or modifications which are within the scope and spirit of the invention as disclosed in the attached claims and their equivalents.

What is claimed is:

1. A server adapted to perform rendering of one or more second images, the server comprising:
a request handler adapted to receive and handle a render request to render the one or more second images using parameters for a first image associated with the render request;
a rendering engine for generating a 3D object using the parameters, and for rendering the one or more second images using the 3D object; and
a processor adapted to control the request handler and the rendering engine,
wherein the one or more second images have a higher resolution than the first image.

2. The server of claim 1, wherein the rendering engine comprises a rendering hardware that is replaceable with other rendering hardware.

3. The server of claim 2, wherein the rendering hardware comprises a video card.

4. The server of claim 1, wherein each of the one or more second images is rendered in less than one second.

5. The server of claim 1, wherein the request handler is adapted to handle multiple render requests from multiple client computers over a computer network.

6. The server of claim 1, wherein the one or more second images are 2D images.

7. The server of claim 6, wherein the one or more second images are JPEG images.

8. A network-based image rendering system comprising:
at least one client computer adapted to generate parameters for a first object having a first resolution; and
a server adapted to receive the parameters for the first object and generate a second object having a second resolution that is greater than the first resolution, wherein the at least one client computer is coupled to the server via a computer network,
wherein the server is further adapted to render one or more 2D images using the second object, and to send the one or more 2D images to the at least one client computer over the computer network.

9. The network-based 3D rendering system of claim 8, wherein the server comprises a rendering hardware for rendering the one or more 2D images, wherein the system is configured such that the rendering hardware in the server can be replaced with another rendering hardware without replacing hardware in the at least one client computer.

10. The network-based 3D rendering system of claim 9, wherein the rendering hardware comprises a video card.

11. The network-based 3D rendering system of claim 8, wherein the at least one client computer is adapted to generate the parameters for the first object using at least one of 3D image processing, 2D image processing or text-based processing.

12. The network-based 3D rendering system of claim 8, wherein the at least one client computer further comprises a monitor for displaying the one or more 2D images.

13. The network-based 3D rendering system of claim 8, wherein the at least one client computer comprises a plurality of client computers, and wherein the server is adapted to concurrently handle requests from the plurality of client computers.

14. The network-based 3D rendering system of claim 13, wherein the plurality of client computers are based on at least two different respective platforms.

15. The network-based 3D rendering system of claim 8, wherein at least one of the client computers comprises a 3D camera input system adapted to be used to create inputs for one or more of camera angles, zooms or pans, and to send the created inputs to the server.

16. A method of generating one or more second images having a second resolution at a server, using parameters for a first image having a first resolution that is lower than the second resolution, the method comprising:
receiving at the server a render request and the parameters for the first image from a client computer;
generating a 3D object corresponding to the one or more second images using the parameters for the first image;
rendering the one or more second images using the 3D object; and
sending the one or more second images from the server to the client computer.

17. The method of claim 16, further comprising manipulating at the client computer a 3D object corresponding to the first image having the first resolution.

18. The method of claim 16, further comprising sending the parameters of the 3D object corresponding to the first image from the client computer to the server over a computer network.

19. The method of claim 16, further comprising creating at the client server inputs for at least one of camera angles, zooms or pans.
